(19) United States
(12) Patent Application Publication
(10) Pub. No.: US 2004/0183826 A1
(43) Pub. Date: Sep. 23, 2004

(54) Method for providing images of real property in conjunction with their directional orientation

(76) Inventors: Jaime R. Taylor, Clarksville, TN (US); Ronald L. Holcomb, Good Spring, TN (US)

Correspondence Address: Donna J. Russell, Baker, Donelson, Bearman,, Caldwell & Berkowitz, P.C., 211 Commerce Street, Suite 1000, Nashville, TN, 37201, US

(21) Appl. No.: 10/782,633

(22) Filed: Feb. 19, 2004

Related U.S. Application Data
(60) Provisional application No. 60/448,053, filed on Feb. 20, 2003.

(51) Int. Cl. G09G 5/00

(52) U.S. Cl. 345/738

(57) ABSTRACT

The invention provides a method for presenting visual information about real property to a prospective buyer or other viewer. The method provides the viewer with the opportunity to understand the orientation of a particular view of an object within a property in terms of the position of that object within or outside the property. The invention is especially useful for providing information regarding real property and the surrounding environment by means of virtual tour that limits the necessity of participating in significant travel to personally view individual properties.

### CROSS REFERENCE TO RELATED APPLICATIONS

This is a non-provisional application that claims the benefit of earlier filed provisional application No. 60/448,053.

### FIELD OF THE INVENTION

The invention relates to methods of providing interactive graphic displays viewed via the internet or another computer-assisted source, as well as to methods of marketing real property using such interactive graphic displays.

### BACKGROUND OF THE INVENTION

Many individuals and businesses purchase, lease, or rent real property each year. In searching for the appropriate property, a significant number of individuals utilize virtual tours provided via the internet. The most common types of media for presenting virtual tours of real property include film, video tape and streaming video. These methods provide an accurate, although occasionally somewhat distorted, pictorial depiction of a particular section of the subject property. These virtual tours, may, however, be limiting to the viewer in that they are intended to allow the viewer to view the images as submitted by the photographer. Generally, little or no opportunity exists for the viewer to view the images in context. Views may be panoramic, but the viewer still has no option to view any spatial area other than that selected by the photographer, and viewers generally have little or no information presented to them about the photographer's location relative to the larger property. Generally, these images are presented when a viewer chooses to view a particular room of a house, for example, without being given an opportunity to understand the position of the house and the orientation of the view within the house. Viewers generally cannot view the house as they would tour the house, gaining an understanding of the position of the rooms, the location of doors and windows, etc.

Most tours of virtual environments provide two-dimensional views of a three-dimensional space representing the virtual environment. These systems require specialized equipment that can be very expensive and unavailable to many individuals, may require special training to operate, and, although they produce good virtual images, also produce images that are time-consuming to produce and may produce a certain degree of distortion when a three-dimensional view is presented in a two-dimensional plane. Use of such virtual tours in the real estate industry can add significantly to the marketing costs for realtors and brokers, and are generally unavailable to those individuals who desire to market their own homes.

Images provided in many virtual tours can require long download times due to the large amounts of data that must be provided in order to present the image. Long download times discourage many potential viewers, who get tired of waiting and leave the site to look for other properties. This results in a lost opportunity for both the buyer and the seller. Furthermore, although these systems are “high tech,” they do not provide the viewer with spatial or directional orientation while viewing the virtual view.

Although some geographic display systems offer a plan view of a particular property, the plan view disappears when a particular room or area view is selected for observation by the viewer, removing the opportunity for the viewer to gain an understanding of the relative position of the particular room or area in the whole of the property. Even for those individuals who are adept at visualizing spatial orientation, having been presented earlier with the plan view, these systems generally do not provide the viewer with an opportunity to understand the perspective from which the picture was taken.

Systems have been developed to utilize combinations of two-dimensional displays representing views of first and second dimensions of a three-dimensional space simultaneously with views of second and third dimensions of the same three-dimensional space. One such example is described in U.S. Pat. No. 6,097,393 (Prouty et al.). This technique, however, manipulates the several views by selection of resource icons within the field of view of the user's environment. This allows the viewer to better visualize the three-dimensional space itself, but is not designed to provide a perspective as to the location of the user's environment within the greater environment.

What is still needed, then, is a method for providing images of objects, such as rooms or areas of real property, so that the viewer can determine from which perspective the viewer wishes to view the room or area and so that the viewer can gain an understanding of the orientation of the room or area within the whole of the property.

### SUMMARY OF THE INVENTION

The present invention relates to a method for providing a virtual tour of real property, the method comprising providing at least one elevation view of each of a series of objects within a property; associating each of the elevation views with an activation signal; associating each of the activation signals with an area of a plan view of the property; and simultaneously displaying the plan view with an elevation view chosen by a viewer through selection of an activation signal. In certain embodiments of the invention, the objects are rooms within a property chosen from the group comprising a single-family home, an apartment complex, a hotel, and a conference center. In other embodiments, the objects are lots within a subdivision or similar parcels of property within a group of parcels.

The method of the invention can also used in a marketing method to provide a prospective buyer, convention or meeting organizer, or other entity with an opportunity to view the objects within and around a subject property while also providing information, or links to information, regarding, for example, local mortgage loan rates, local mortgage lenders, property taxes, property condition disclosures, utility companies and other information desired by a prospective buyer. In this manner, a prospective buyer or meeting organizer can utilize the method of the invention to maximize the amount of information that can be obtained regarding a property and the surrounding community, while minimizing travel time and associated expense.

### BRIEF DESCRIPTION OF THE DRAWINGS

FIG. 1 is an illustration of a screen display for viewing a three-dimensional space as found in the prior art (U.S. Pat. No. 6,097,393, issued Aug. 1, 2000).

FIG. 2 is a layout or floor plan, or plan view, of a single-floor building such as a commercial building, as provided by the method of the present invention, with a corresponding elevation view, the position and direction of the elevation view being represented by a directional icon 6 within the plan view.

FIG. 3 provides an example of a plan view and associated elevation view, with additional positional or directional information or options being associated with identification icons, as shown.

FIG. 4 is a schematic of a selected elevation view of a multi-story house. Buttons, or identification icons, such as those shown in FIG. 3, with object names, can be used to activate the specific elevation view or plan view that the viewer desires to view.

FIG. 5 is a diagram illustrating the representative steps of the method of the present invention.

### DETAILED DESCRIPTION

The present invention relates to a method for providing one or more individual views of rooms or areas of real property so that spatial orientation of the one or more views is indicated and the viewer is better able to “tour” the property from a distance by means of a “virtual tour” provided via computer.

As used herein, “object” is used interchangeably with “room,” “area,” or any sub-component of real property which a viewer desires to view within the context of the whole. “Elevation view” means a geometric projection such as a photographic image, sketch, or CAD drawing of an object, on a vertical plane (including, but not limited to, a view at a right angle to the 2-D planar view, or a view at a 180° angle to the 2-D planar view). “Activation signal” refers to, but is not limited to, a directional icon, a positional icon, a “hot spot” on a plan view of a property, or an informational icon.

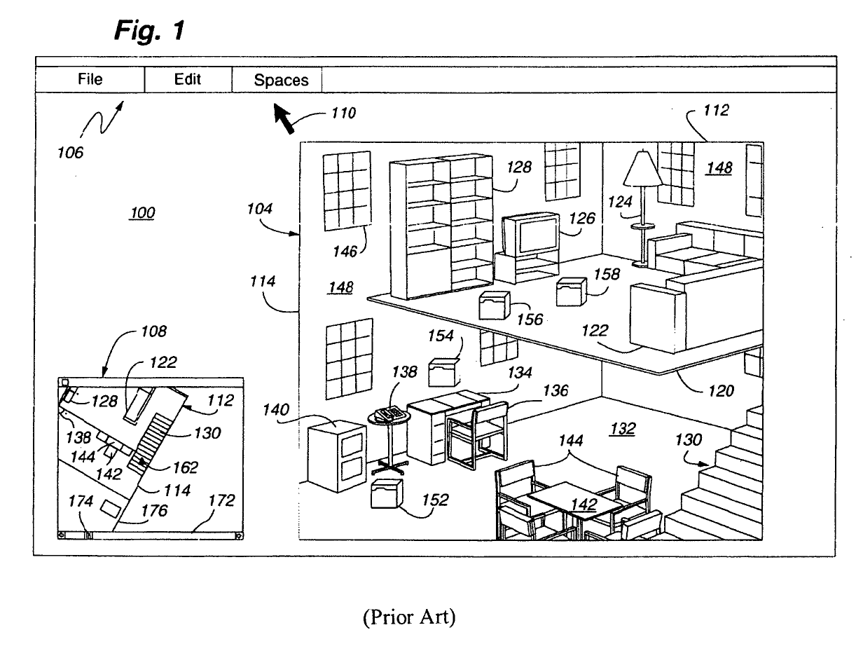

Turning now to FIG. 1, there is shown generally a depiction of the images available to the viewer in the method of the present invention. A plan view 2 of the building, apartment, subdivision, or other property to be viewed is provided simultaneously on, for example, a computer monitor with at least one elevation view of an object within the property 4. “Simultaneously,” as used herein, means within a time frame that allows the viewer to maintain an awareness of the position of the object within the whole property or a portion thereof. In order to ascertain the position of the object described by an individual elevation view, the object is associated with a directional or positional icon, such as an arrow 6. The icon may indicate the direction of the view provided by the elevation view, the position from which the view was taken, or both. “Directional” icons therefore can be used interchangeably with “positional” icons in the method of the present invention to indicate the direction or position from which the elevation view was obtained. In order to indicate the direction of the view and the position of the object within the property, it is not necessary that the “directional” icon be an arrow, but may also comprise any of a variety of icons placed so that the position of the object and the direction from which the viewer is able to view the object are apparent to the viewer.

In order to provide a tour of a property, a series of elevation views should be provided. These views can be stored in a central server, a regional server, or on a compact disc or other similar media to be provided to a customer who desires to search for and tour properties by a virtual tour mechanism. Preferably, a sufficient number and variety of elevation views are provided, each associated with a directional icon indicating the position or direction of the view of the object (or both) within the property, so that the viewer can view at least two views of each object. In another embodiment, a single view of each of the objects most important to an understanding of the nature of the property may be sufficient to provide a tour of the property. What is most important is that the plan view, with its associated directional icons or “hot spots” (areas of the screen associated with activation of a specific elevation view), be available to the viewer along with the appropriate elevation view chosen by the viewer so that the viewer can identify the position of the object represented by the elevation view within the property.

Directional icons may also be associated with identification icons 8 which can provide, for example, additional information as to identification of the object, the direction of the elevation view or views, or the position of the object within the property. As the viewer chooses an identification icon via a mouse click, the touch of a key corresponding to the icon, or other means for making a selection, the selection activates presentation of an elevation view of the selected view of the object. It is preferable to utilize directional icons, and even more preferable to utilize both directional and identification icons, but it is to be understood that the method of the present invention also provides the option for the viewer to select an area of an object or a property, without selecting a specific icon, with an elevation view that is associated most closely with the area selected being activated for viewing by the viewer. The invention also provides the option of associating an elevation view with a particular informational icon (a button marked “kitchen,” for example) so that the viewer can view the plan view and choose elevation views of individual rooms in an order chosen by the viewer with the benefit of the orientation provided by the plan view.

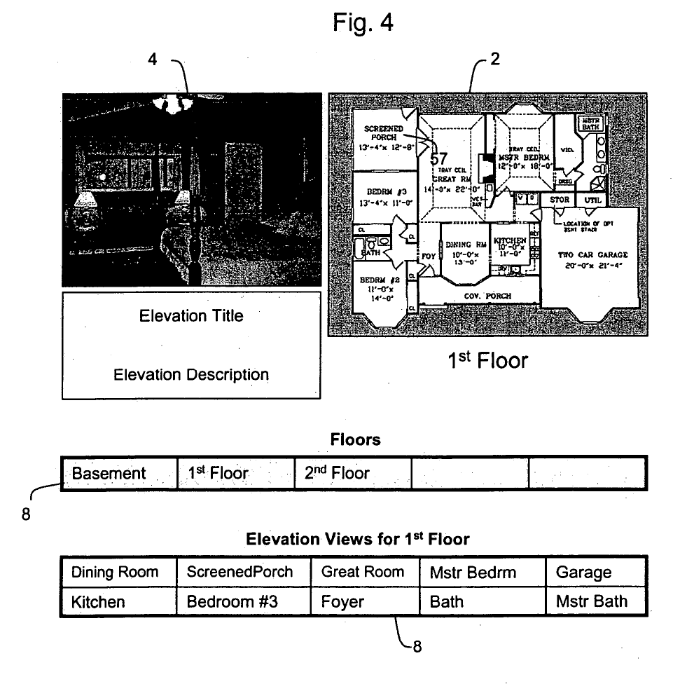

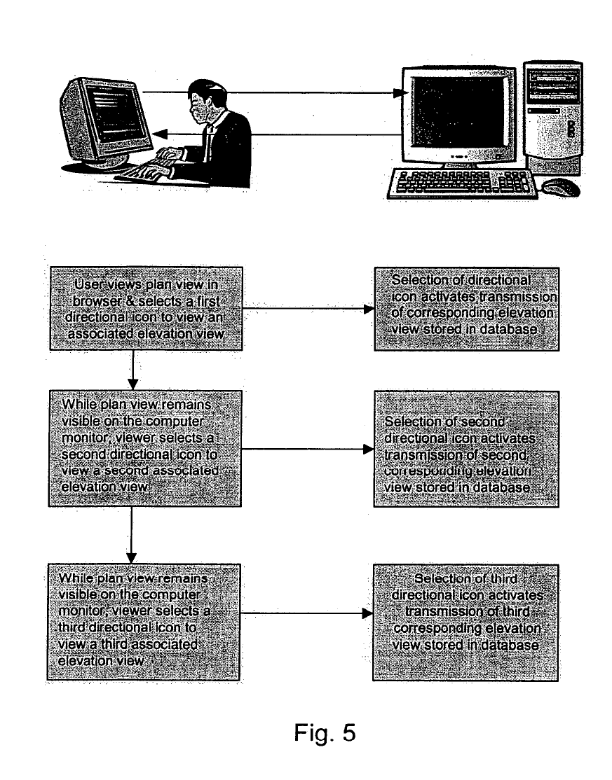

Since the plan view remains visible to the viewer as the elevation views are selected and presented, and since a variety of elevation views are available to the viewer, representing a variety of positional and directional views of one or more objects within the property, it is possible for the viewer to make selections in an order that allows the viewer to view positional and directional views of each object as they would be viewed if the viewer were to walk through the property-standing first at a doorway, then along a specific wall or window. A viewer might begin, for example, by selecting a view of the covered porch as in FIG. 4, viewed from the front sidewalk. The next selection might comprise a view from the front door looking into the foyer. As FIG. 5 illustrates, each viewer selection activates transmission of the appropriate image file from the server, CD, or other storage media, to provide the viewer with the elevation view corresponding to the viewer's selection. The next selection, for example, might comprise a view of the great room from the foyer. Following that, the viewer might wish to view the backyard from the door in the great room. By presenting the plan view in conjunction with the elevation view, and by presenting the viewer with a series of views of the several objects within a property in their directional and positional context, the method of the present invention makes it possible to present a more realistic “tour” of the property for the viewer, who is likely to be a prospective buyer.

While the method of the present invention is ideal for the marketing and sale of residential real estate, its use is not limited to presentation of views of residential real estate. For example, a hotel chain might provide representative plan views of certain floors of a hotel in association with elevation views of representative rooms, so that a prospective traveler and guest might determine which rooms are more desirable, and therefore submit a request for a reservation for one of the more desirable rooms for the various preferences of the individual guest. The method would be particularly useful for hotels and conference centers wishing to attract business through conferences, conventions, and other meeting events. The hotel or conference center could provide representative plan views of the facility or facilities available to event planners, in association with the several elevation views corresponding to objects within the properties, making it possible for event planners to tour the facilities from a distance via the internet, a compact disc, or other means.

For developers wishing to market subdivision lots, one or more plan views representing a map of the subdivision with lot numbers indicated thereon can be presented to prospective buyers in association with photographs representing elevation views of the various lots. By providing several elevation views of the lots within the plat, and associating those views with a plan view of the whole property or a portion thereof, it is possible to provide the prospective buyer with an opportunity, by selecting the direction and position of the view, to understand the position of the lot relative to other lots, the topography of the lot, the view from the lot, and other aspects of the property that are generally not available to a prospective buyer without a personal on-site visit to the property. This is especially useful when the prospective buyer is located a great distance from the property, such as an individual or individuals who are in the process of relocating from one state to another due to a job transfer. The method of the present invention enables such individuals to narrow down the results of their property searches before they must personally make a trip to view the property in person in order to make a final determination regarding the purchase.

The method of the present invention is also appropriate for use by businesses that require the services or products of vendors who must provide cost estimates for their goods or services. For example, a building to be renovated can be presented by the method of the present invention, so that prospective contractors from various geographic regions can tour the property in order to begin to formulate estimates of the necessary work to be done, the materials needed to accomplish the work, etc.

The method of the invention can also be used to provide tours of schools or colleges for parents of prospective students, as a marketing tool for shopping malls (where a tour of the mall can be presented to a prospective shopper), as a marketing tool for builders or developers who desire to provide tours of their existing facilities in order to attract new business, or any such use where it is desirable to provide several views of objects within a property, or views of a property, in their directional and positional context.

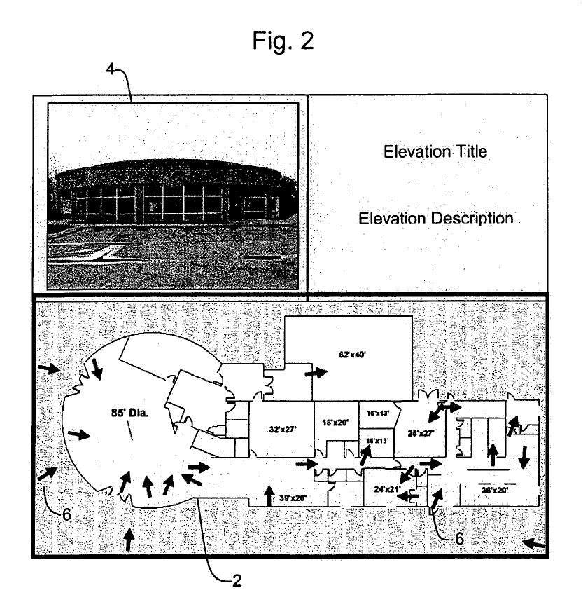

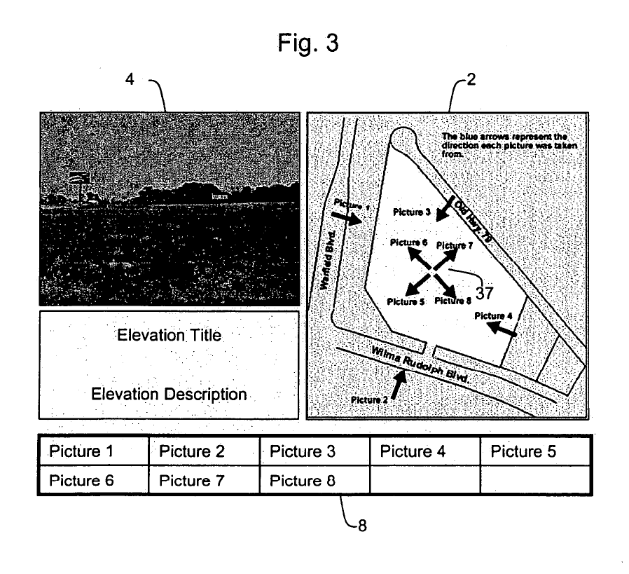

To create a tour of a property as provided by the method of the present invention, a property owner, realtor, or other individual obtains pictures representing elevation views of several objects within a property, the elevation views being obtained from multiple directions and positions within the property. A plan view of the property can then be created. Elevation views representing the various positions within the property are scanned, or otherwise entered into a computer processor, and are associated with directional icons placed on the plan view, as shown in FIGS. 2-4, so that selection of the icons by a viewer of the plan view will activate presentation of a corresponding elevation view.

In one embodiment of the invention, the method is adapted for use by individuals who desire to sell their own homes. Since the photographs or drawings representing the elevation views used in the method of the invention are two-dimensional images, a homeowner can utilize a digital camera, a camera requiring the use of film, or other similar device to take pictures of the various rooms within the home and the exterior of the home. The photographs can be scanned into a computer so that they can be sent via e-mail to a centralized multiple listing service that provides tours of residential real estate by the method of the invention. Alternatively, the photographs or the media within which they are contained can be delivered to a processing facility for the listing service, where the photographs are entered into the computer. Once entered, the several views can be associated with the appropriate areas of the house, the entire house being represented by the plan view. The appropriate elevation views can be indicated on the plan view by means of directional icons, or, as the invention is embodied in FIG. 4, the elevation views can be indicated on the plan view by means of directional icons, indicated by informational icons, or both. To those of skill in the art, it is then only necessary to provide appropriate programming language to the computer system of choice to provide for activation of presentation of a particular elevation view when the corresponding directional icon or informational icon is chosen.

The method of the present invention can also be used in conjunction with an internet web-based database that provides, in conjunction with the simultaneous presentation of plan views and corresponding elevation views for a particular property, information regarding the community within which the subject property is located, information regarding local mortgage loan rates, local mortgage lenders, property taxes, property condition disclosures, and other information desired by a prospective buyer. By providing a tour of the property by the method of the invention while additionally providing community information and hyperlinks to local businesses, utility companies, etc., a real estate listing company can provide to a prospective buyer many miles from the relocation site a significant amount of information that would normally require that the prospective buyer travel many miles to visit the community and the subject property. The method of the present invention, and the method of its use in marketing property, can eliminate significant travel costs associated with relocation and can help a prospective buyer better utilize limited time in order to make informed choices about specific subject properties.

In order to place plan views and associated elevation views within the storage media for use in the method of the invention, a home seller, hotel administrator, convention center administrator, or other individual, for example, need only to take a series of photographs, noting the location or direction, or both, from which each is taken. The photographs can be digital, or produced by means of a conventional film camera and scanned to digitize the images. The images can then be sent by e-mail to the service provider that maintains the database servers, or can be mailed, for example, with the images stored on a compact disc or other media. Alternatively, the service provider can also provide the photography service, which represents significantly less cost to the prospective home seller than does the cost of obtaining the panoramic views often associated with virtual tours, and which involve the use of specialized equipment and trained personnel. The service provider then associates activation signals with the several elevation views on the plan view as visualized on the computer monitor, creating a link between selection of the appropriate activation signal and presentation of the corresponding elevation view.

While the invention has been described in terms of various embodiments, they are not intended to be limiting and it is understood that the invention may be practiced in a variety of ways that add, substitute, or delete certain aspects described in certain embodiments mentioned herein without deviating from the scope and purpose of the invention.

We claim:

1. A method of providing a virtual tour of real property, the method comprising
providing at least one elevation view of each of a series of objects within a property;
associating each of the elevation views with an activation signal;
associating each of the activation signals with an area of a plan view of the property; and
simultaneously displaying the plan view with an elevation view chosen by a viewer through selection of an activation signal.

2. The method of claim 1, wherein the activation signal is a directional icon.

3. The method of claim 1, wherein the objects are rooms within a property chosen from the group comprising a single-family home, an apartment complex, a hotel, and a conference center.

4. The method of claim 1 further comprising providing at least one hyperlink to direct the viewer to a website providing information about community service providers selected from the group comprising utility companies, schools, churches, vendors, and mortgage companies.
